(19) United States
(12) Patent Application Publication
(10) Pub. No.: US 2016/0253764 A1
(43) Pub. Date: Sep. 1, 2016

(54) FLEXIBLE TARGETING

(71) Applicant: LinkedIn Corporation, Mountain View, CA (US)

(72) Inventors: Omar Sinno, San Francisco, CA (US); Adrian Axel Remigo Fernandez, Mountain View, CA (US); Ya Xu, Los Altos, CA (US); Adam Smyczek, San Mateo, CA (US); Nanyu Chen, San Francisco, CA (US); Erin Louise Delacroix, Saratoga, CA (US)

(21) Appl. No.: 14/944,100

(22) Filed: Nov. 17, 2015

Related U.S. Application Data
(60) Provisional application No. 62/126,169, filed on Feb. 27, 2015.
(60) Provisional application No. 62/155,419, filed on Apr. 30, 2015.

(51) Int. Cl. G06Q 50/00; G06F 3/0484; G06Q 10/10

(52) U.S. Cl. CPC G06Q 50/01; G06Q 10/10; G06F 3/04842

(57) ABSTRACT

Techniques for conducting A/B experimentation of online content are described. According to various embodiments, a user specification of targeting criteria defining a targeted segment of members of an online social networking service for an A/B experiment is received. A set of members of the online social networking service satisfying the user-specified targeting criteria is then identified. Thereafter, a user specification of allocation criteria defining one or more variants of an A/B experiment and one or more corresponding allocation percentages is received. A subset of the set of members (corresponding to the user-specific allocation percentage associated with the respective user-specified variant) is then assigned to each of the user-specified variants. Further, at least one data record associated with each of the variants is recorded in a database, each data record indicating the subset of the set of members assigned to the respective variant.

### RELATED APPLICATIONS

This application claims the benefit of priority to U.S. Provisional Application Ser. No. 62/126,169, filed Feb. 27, 2015, and U.S. Provisional Application Ser. No. 62/155,419, filed Apr. 30, 2015, which are incorporated herein by reference in their entirety.

### TECHNICAL FIELD

The present application relates generally to data processing systems and, in one specific example, to techniques for conducting A/B experimentation of online content.

### BACKGROUND

The practice of A/B experimentation, also known as “A/B testing” or “split testing,” is a practice for making improvements to webpages and other online content. A/B experimentation typically involves preparing two versions (also known as variants, or treatments) of a piece of online content, such as a webpage, a landing page, an online advertisement, etc., and providing them to separate audiences to determine which variant performs better.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the present disclosure;

FIG. 2 is a block diagram of an example system, according to various embodiments;

FIG. 3 is a diagram illustrating a targeted segment of members, according to various embodiments;

FIG. 4 is a diagram illustrating a portion of a system, according to various embodiments;

FIG. 5 is a flowchart illustrating an example method, according to various embodiments;

FIG. 6 illustrates examples of information stored in a database, according to various embodiments;

FIG. 7 is a flowchart illustrating an example method, according to various embodiments;

FIG. 8 illustrates an example mobile device, according to various embodiments; and

FIG. 9 is a diagrammatic representation of a machine in the example form of a computer system within which a set of instructions, for causing the machine to perform any one or more of the methodologies discussed herein, may be executed.

### DETAILED DESCRIPTION

Example methods and systems for conducting A/B experimentation of online content are described. In the following description, for purposes of explanation, numerous specific details are set forth in order to provide a thorough understanding of example embodiments. It will be evident, however, to one skilled in the art that the embodiments of the present disclosure may be practiced without these specific details.

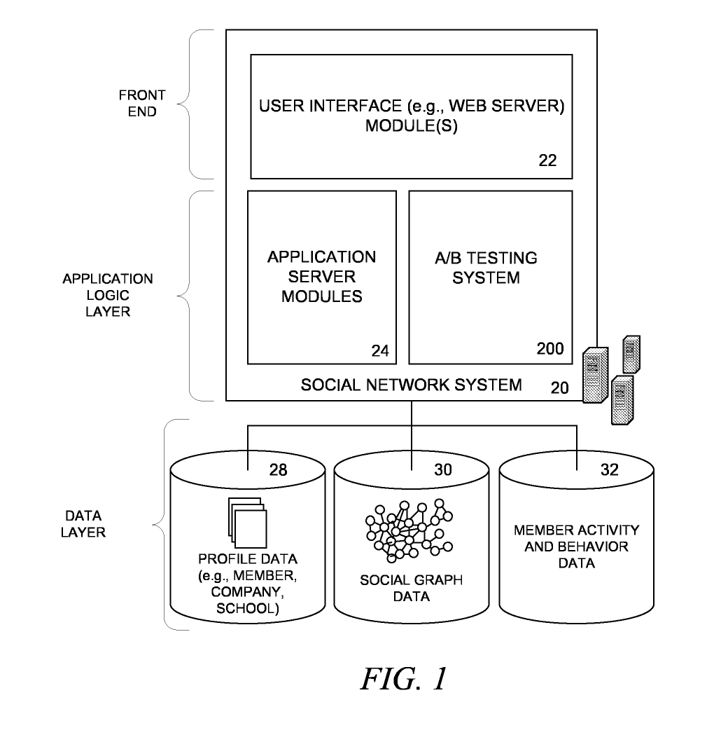

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, hometown, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32.

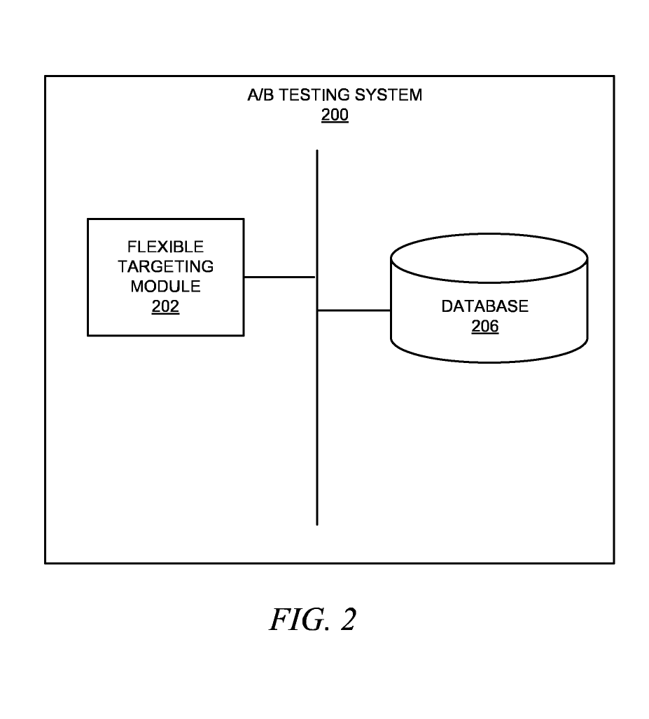

With some embodiments, the social network system 20 includes what is generally referred to herein as an A/B testing system 200. The A/B testing system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

According to various example embodiments, an A/B experimentation system is configured to enable a user to prepare and conduct an A/B experiment of online content among members of an online social networking service such as LinkedIn®. The A/B experimentation system may display a targeting user interface allowing the user to specify targeting criteria statements that reference members of an online social networking service based on their member attributes (e.g., their member profile attributes displayed on their member profile page, or other member attributes that may be maintained by an online social networking service that may not be displayed on member profile pages). In some embodiments, the member attribute is any of location, role, industry, language, current job, employer, experience, skills, education, school, endorsements of skills, seniority level, company size, connections, connection count, account level, name, username, social media handle, email address, phone number, fax number, resume information, title, activities, group membership, images, photos, preferences, news, status, links or URLs on a profile page, and so forth. For example, the user can enter targeting criteria such as “role is sales”, “industry is technology”, “connection count >500”, “account is premium”, and so on, and the system will identify a targeted segment of members of an online social network service satisfying all of these criteria. The system can then target all of these users in the targeted segment for online A/B experimentation.

Once the segment of users to be targeted has been defined, the system allows the user to define different variants for the experiment, such as by uploading files, images, HTML code, webpages, data, etc., associated with each variant and providing a name for each variant. One of the variants may correspond to an existing feature or variant, also referred to as a “control” variant, while the other may correspond to a new feature being tested, also referred to as a “treatment”. For example, if the A/B experiment is testing a user response (e.g., click through rate or CTR) for a button on a homepage of an online social networking service, the different variants may correspond to different types of buttons such as a blue circle button, a blue square button with rounded corners, and so on. Thus, the user may upload an image file of the appropriate buttons and/or code (e.g., HTML code) associated with different versions of the webpage containing the different variants.

Thereafter, the system may display a user interface allowing the user to allocate different variants to different percentages of the targeted segment of users. For example, the user may allocate variant A to 10% of the targeted segment of members, variant B to 20% of the targeted segment of members, and a control variant to the remaining 70% of the targeted segment of members, via an intuitive and easy to use user interface. The user may also change the allocation criteria by, for example, modifying the aforementioned percentages and variants. Moreover, the user may instruct the system to execute the A/B experiment, and the system will identify the appropriate percentages of the targeted segment of members and expose them to the appropriate variants.

Turning now to FIG. 2, an A/B testing system 200 includes a flexible targeting module 202 and a database 206. The modules of the A/B testing system 200 may be implemented on or executed by a single device such as an A/B testing device, or on separate devices interconnected via a network. The aforementioned A/B testing device may be, for example, one or more client machines or application servers. The operation of each of the aforementioned modules of the A/B testing system 200 will now be described in greater detail in conjunction with the various figures.

To run an experiment, the A/B testing system 200 allows a user to create a testKey, which is a unique identifier that represents the concept or the feature to be tested. The A/B testing system 200 then creates an actual experiment as an instantiation of the testKey. Such hierarchical structure makes it easy to manage experiments at various stages of the testing process. For example, suppose the user wants to investigate the benefits of adding a background image. The user may begin by diverting only 1% of US users to the treatment, then increasing the allocation to 50% and eventually expanding to users outside of the US market. Even though the feature being tested remains the same throughout the ramping process, it requires different experiment instances as the traffic allocations and targeting changes. In other words, an experiment acts as a realization of the testKey, and only one experiment per testKey can be active at a time.

Every experiment is comprised of one or more segments, with each segment identifying a subpopulation to experiment on. For example, a user may set up an experiment with a “whitelist” segment containing only the team members developing the product, an “internal” segment consisting of all company employees and additional segments targeting external users. Because each segment defines its own traffic allocation, the treatment can be ramped to 100% in the whitelist segment, while still running at 1% in the external segments. Note that segment ordering matters because members are only considered as part of the first eligible segment. After the experimenters input their design through an intuitive User Interface, all the information is then concisely stored by the A/B testing system 200 in a DSL (Domain Specific Language). For example, the line below indicates a single segment experiment targeting English-speaking users in the US where 10% of them are in the treatment variant while the rest in control:

(ab(=(locale)“en_US”)[treatment 10% control 90%])

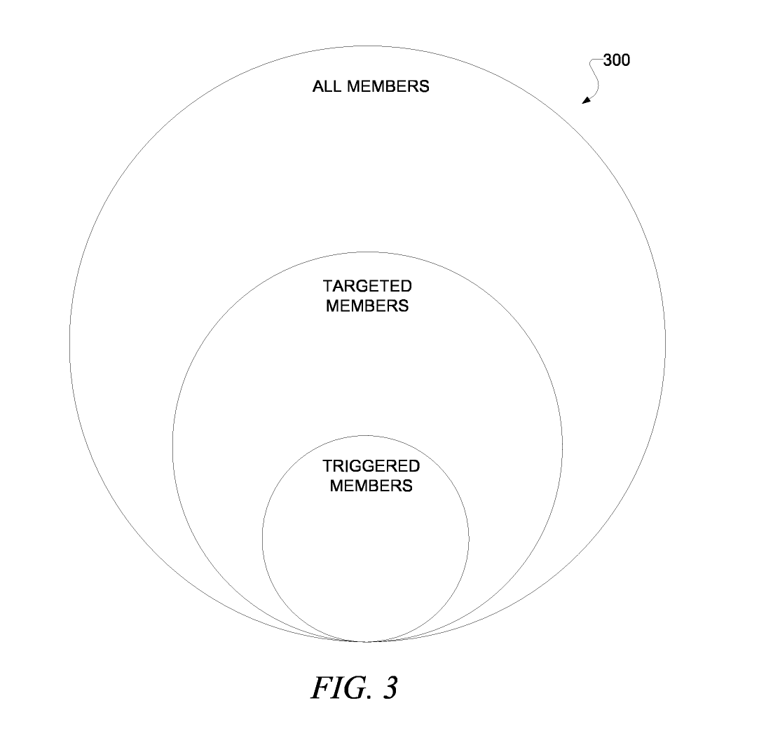

In some embodiments, the A/B testing system 200 may log data every time a treatment for an experiment is called, and not simply for every request to a webpage on which the treatment might be displayed. This not only reduces the logs footprint, but also enables the A/B testing system 200 to perform triggered analysis, where only users who were actually impacted by the experiment are included in the A/B test analysis. For example, LinkedIn.com could have 20 million daily users, but only 2 million of them visited the “jobs” page where the experiment is actually on. Without such trigger information, it is difficult to isolate the real impact of the experiment from the noise, especially for experiments with low trigger rates. For example, as illustrated in diagram 300 in FIG. 3, an experiment may be targeted at a targeted segment of members or “targeted members”, who are a subpopulation of “all members” of an online social networking service. Moreover, the experiment will only be triggered for “triggered members”, which is the subpopulation of the “targeted members” who are actually impacted by the experiment (e.g., that actually interact with the treatment).

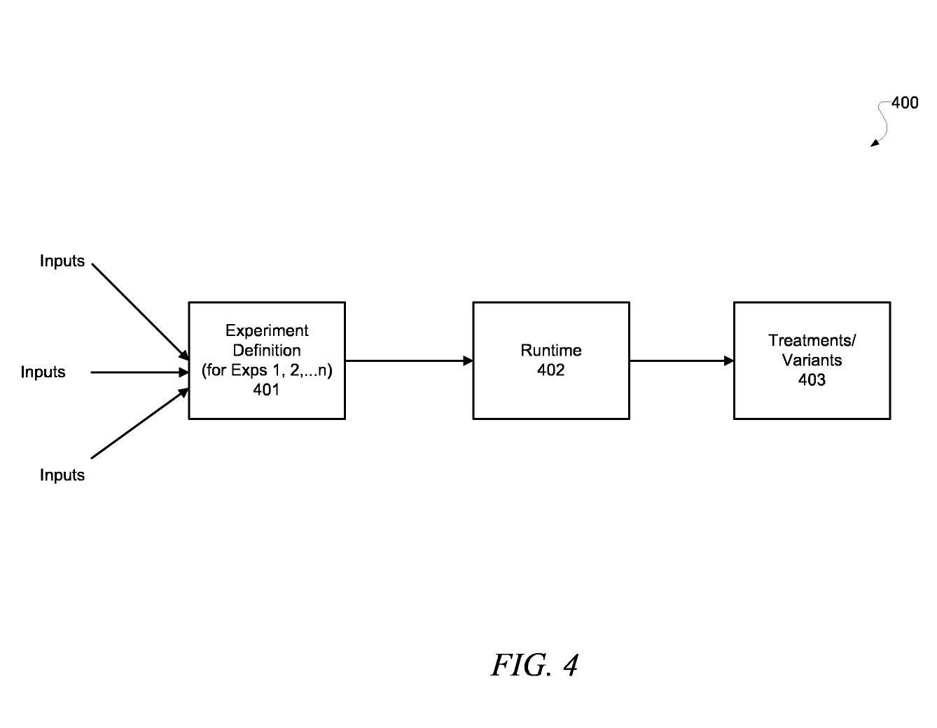

According to various example embodiments, the A/B testing system 200 enables an operator of the A/B testing system 200 to easily and flexibly target variants of an experiment to different members. For example, as illustrated in FIG. 4, the A/B testing system 200 includes an experiment definition component 401 configured to store a basic description or an experiment definition for various experiments 1, 2, . . . n. As described herein, the A/B testing system 200 may display a user interface allowing a user to enter a flexible targeting command as described in more detail below. Thus, the experiment definition component receives various inputs (e.g., the flexible targeting command) and includes language constructs that help define the specification or basic definition of an experiment.

The A/B testing system 200 allows the operator to generate the flexible targeting commands by allowing the user to operate with member features, where the flexible targeting commands are extensible to other kinds of entities, such as Influencers, Jobs, Groups, Schools, and so on. The form of the flexible targeting command may be: (ab connection_count_>100 [V1 50%]). The flexible targeting command is composed of a targeting portion (e.g., “ab connection_count_>100”), and an allocation portion (e.g., “[V1 50%]”).

The example targeting portion above includes a segment identifier (e.g., “ab”) identifying a particular member segment 0 . . . n that is described in the flexible targeting command. The targeting portion also defines a Boolean expression (e.g., “connection_count_>100”), such as a series of operations or a formula that return a Boolean value. In the example above, the Boolean expression identifies all users having a connection count of greater than 100 connections. The aforementioned Boolean expressions is user defined, and determines whether the A/B testing system 200 will allocate variants to a given member id. If so, the A/B testing system 200 will refer to the allocation portion (e.g., “[V1 50%]”) described in more detail below to determine the correct treatment for this member id. The Boolean expression may include many commands, such as: Selectors (e.g., >, <, =, etc.), custom functions, and runtime attributes or attributes. Examples of custom functions include: tagged functions (e.g., a specific batch of tagged IDs defining the relevant member segment), in-list functions such as “in-list (date selector) #days” (e.g., “in-list registration date 30 days” which will cause the A/B testing system 200 to select all the members that have registered in the last 30 days), “in” functions, and “not” functions. While the examples above refer to member-based selectors, other selectors for other entities may be used, such as group based selectors (e.g., if group size is greater than X, display feature), school-based selectors, contract entity based selectors (e.g., if contract w/ customer is older than 2 years, do not display feature), etc.

The allocation portion of the flexible targeting command includes a list (or table), defining treatments 1 . . . n and corresponding allocation percentages. For instance, in the example above, the variant/treatment V1 will be allocated to 50% of the member segment defined by the targeting portion. In some embodiments, the A/B testing system 200 will automatically assign the other 50% of the targeted population to the control variant. The allocation portion of the flexible targeting command effectively defines a number of people for each variant, and the hashing function described below is used to select the actual member IDs for allocation.

The embodiments described herein may be utilized for targeting features independent of A/B testing. For example, various embodiments may be utilized to expose a new feature to a specific set of users, without experimental concerns regarding analytics and measuring improvements to metrics.

As illustrated in FIG. 4, the A/B testing system 200 includes a runtime component 402 that corresponds to machinery that implements the targeting and allocation elements described in the specification maintained by the experiment definition component 401. The implementations generated by the runtime component are essentially programming code that can include Java implementations, JavaScript implementations, etc., that perform the allocation described in the experiment definition. In some embodiments, the runtime component executes an ID hashing function for allocating specific members to a given variant. For example, an ID hashing function may correspond to a formula such as: f(m_{ID}, seed), which takes an inputs an arbitrary member id m_{ID}, and a seed number or seed ID, and determines whether that given member is in a seed group corresponding to the seed number. For example, the seed number may correspond to a distribution identifier that allows the A/B testing system 200 to select a specific distribution, such that different seed numbers will render different distributions of members belonging to a seed group. This ensures that different experiment will be performed on different set of members. In other words, if two experiments are running simultaneously, they will be independent and should not collide or interfere with each in terms of the members being experimented on. If experiments are otherwise performed on the same population at the same time, it may become difficult to determine which features being tested in each experiment have resulted in improved metrics (e.g., when the features being experiment upon are on the same webpage such as a homepage).

After the definition component 410 generates the basic description of the experiment, and the runtime component 402 implements the hashing, targeting, and allocation elements of the basic description of the experiment, the runtime component 402 outputs treatment/variant information 403 indicating which member ID is going to receive each variant.

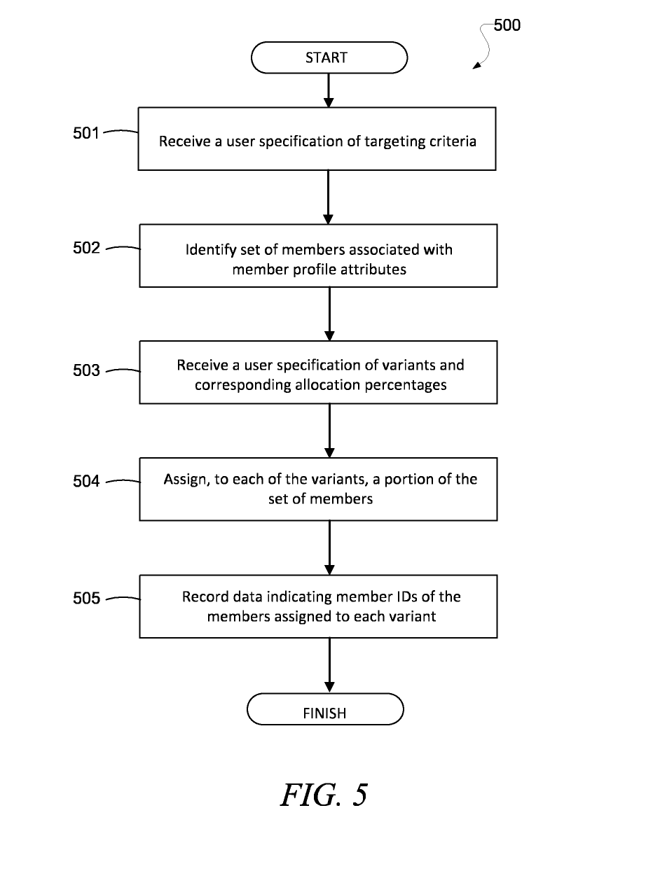

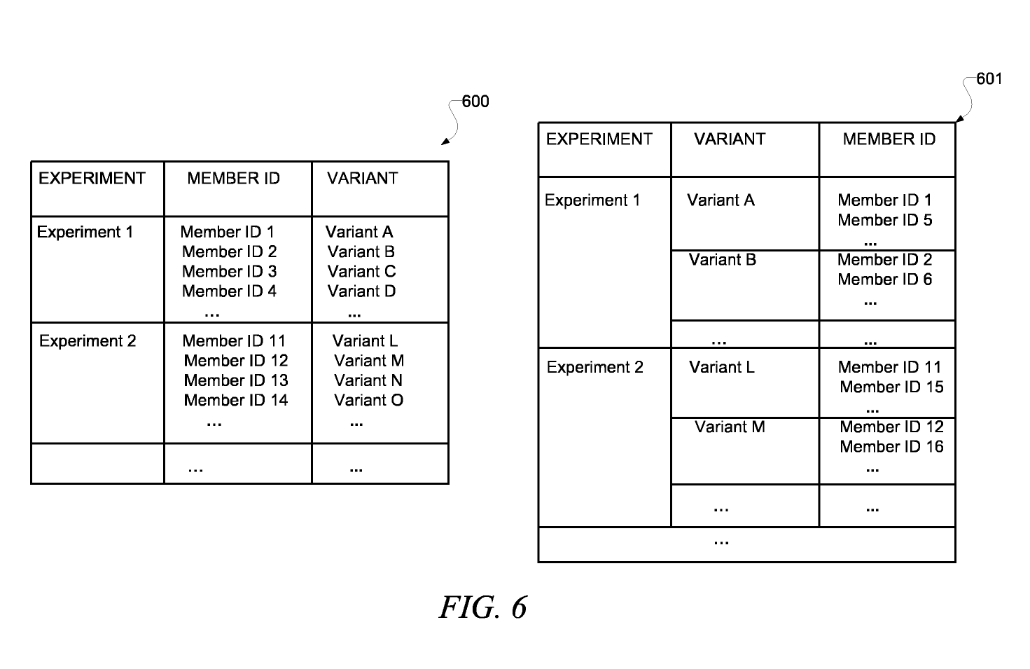

FIG. 5 is a flowchart illustrating an example method 500 for generating treatment/variant information indicating member IDs and a correct variant associated with each of the member IDs, consistent with various embodiments described herein. The method 500 may be performed at least in part by, for example, the A/B testing system 200 illustrated in FIG. 2 (or an apparatus having similar modules, such as one or more client machines or application servers). In operation 501, the flexible targeting module 204 receives a user specification of targeting criteria (e.g., the targeting portion of the flexible targeting commands described herein) defining a targeted segment of members of an online social networking service for an A/B experiment. In operation 502, the flexible targeting module 204 identifies a set of members of the online social networking service that satisfies the targeting criteria specified in operation 501. For example, if the targeting criteria is specified in connection with member profile attributes (e.g., members utilizing an Android device with more than 500 connections, located in the U.S., and having the skill of “marketing” of their member profile), then the flexible targeting module 204 may identify members of the online social network service that are associated with these member profile attributes. Examples of member profile attributes include location, role, industry, language, current job, employer, experience, skills, education, school, endorsements of skills, seniority level, company size, connections, connection count, account level, name, username, social media handle, email address, phone number, fax number, resume information, title, activities, group membership, images, photos, preferences, news, status, links or URLs on a profile page, and so forth. In operation 503, the flexible targeting module 204 receives a user specification of one or more variants of an A/B experiment and one or more corresponding allocation percentages (e.g., via the allocation portion of the flexible targeting commands described herein). In operation 504, the flexible targeting module 204 assigns, to each of the variants specified in operation 503, a portion of the set of members (identified in operation 502) equal to the corresponding allocation percentage specified in operation 503. For example, if the user specification in operation 503 is “[A 50%]”, then the flexible targeting module 204 assigns, to variant A, 50% of the set of targeted members identified in operation 502. In operation 505, the flexible targeting module 204 records, in a database, member-variant information indicating, for each of a plurality of A/B experiments, a list of member IDs and a correct variant associated with each of the member IDs (e.g., see member-variant information 600 in FIG. 6). Alternatively, the flexible targeting module 204 records, in a database, at least one data unit associated with each of the variants, each data unit indicating member IDs of the members assigned to the corresponding variant (e.g., see member-variant information 601 in FIG. 6). It is contemplated that the operations of method 500 may incorporate any of the other features disclosed herein. Various operations in the method 500 may be omitted or rearranged, as necessary.

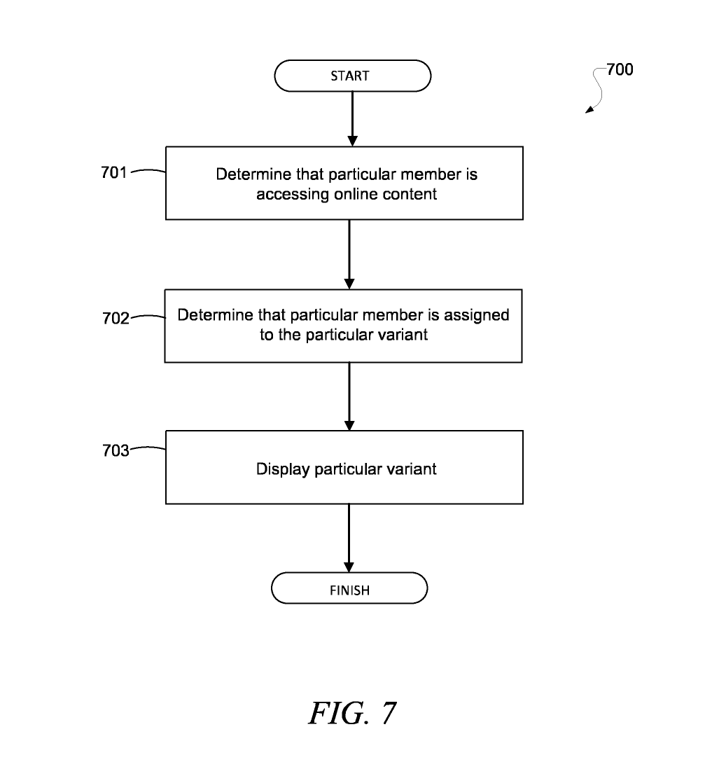

FIG. 7 is a flowchart illustrating an example method 700, consistent with various embodiments described herein. The method 700 may be performed at least in part by, for example, the 200 illustrated in FIG. 2 (or an apparatus having similar modules, such as one or more client machines or application servers). In operation 701, the 202 determines that a particular member is accessing online content associated with an A/B experiment. In operation 702, the 202 determines, based on a data record associated with a particular variant (e.g., the data record described in operation 505), that the particular member in operation 701 is included in a particular subset of members that is assigned to the particular variant. In operation 703, the 202 displays, via a user interface on a client device associated with the particular member, the particular variant assigned to the particular member in conjunction with the online content. It is contemplated that the operations of method 700 may incorporate any of the other features disclosed herein. Various operations in the method 700 may be omitted or rearranged.

### Example Mobile Device

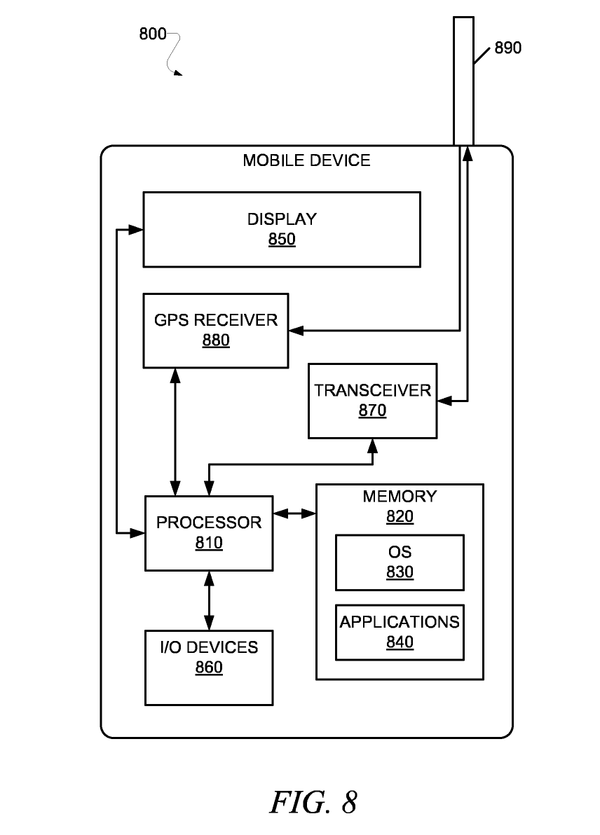

FIG. 8 is a block diagram illustrating the mobile device 800, according to an example embodiment. The mobile device may correspond to, for example, one or more client machines or application servers. One or more of the modules of the system 200 illustrated in FIG. 2 may be implemented on or executed by the mobile device 800. The mobile device 800 may include a processor 810. The processor 810 may be any of a variety of different types of commercially available processors suitable for mobile devices (for example, an XScale architecture microprocessor, a Microprocessor without Interlocked Pipeline Stages (MIPS) architecture processor, or another type of processor). A memory 820, such as a Random Access Memory (RAM), a Flash memory, or other type of memory, is typically accessible to the processor 810. The memory 820 may be adapted to store an operating system (OS) 830, as well as application programs 840, such as a mobile location enabled application that may provide location based services to a user. The processor 810 may be coupled, either directly or via appropriate intermediary hardware, to a display 850 and to one or more input/output (I/O) devices 860, such as a keypad, a touch panel sensor, a microphone, and the like. Similarly, in some embodiments, the processor 810 may be coupled to a transceiver 870 that interfaces with an antenna 890. The transceiver 870 may be configured to both transmit and receive cellular network signals, wireless data signals, or other types of signals via the antenna 890, depending on the nature of the mobile device 800. Further, in some configurations, a GPS receiver 880 may also make use of the antenna 890 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

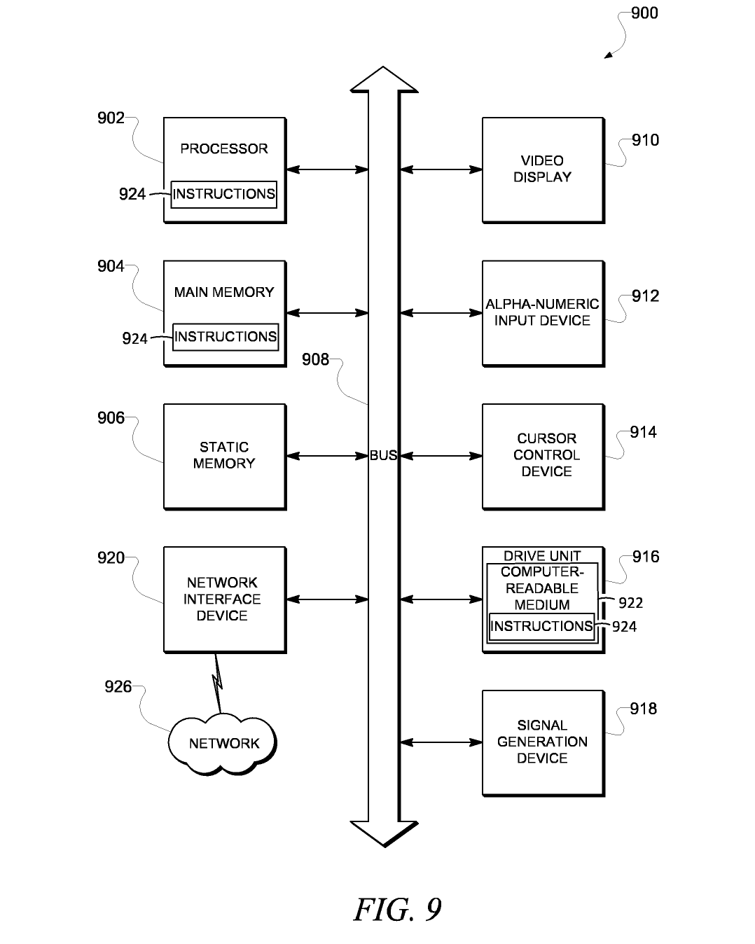

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi, LTE, and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, via a user interface, a user specification of targeting criteria defining a targeted segment of members of an online social networking service for an A/B experiment
identifying a set of members of the online social networking service satisfying the user-specified targeting criteria, based on member profile attributes of the set of members;
receiving, via the user interface, a user specification of allocation criteria defining one or more variants of an A/B experiment and one or more corresponding allocation percentages;
assigning, to each of the user-specified variants, a subset of the set of members corresponding to the user-specific allocation percentage associated with the respective user-specified variant; and
recording, in a database, at least one data record associated with each of the variants, each data record indicating the subset of the set of members assigned to the respective variant.

2. The method of claim 1, further comprising:
determining that a particular member is accessing online content associated with the A/B experiment;
determining, based on the data record associated with a particular variant, that the particular member is included in a particular subset of the set of members that is assigned to the particular variant; and
displaying, via a user interface on a client device associated with the particular member, the particular variant in conjunction with the online content.

3. The method of claim 1, wherein the assigning further comprises identifying the members in each subset based on a hashing function.

4. The method of claim 1, wherein the user specification of the targeting criteria corresponds to a textual command including a member profile attribute and a value associated with the member profile attribute.

5. The method of claim 4, wherein the member profile attribute corresponds to a location, role, industry, language, skill, company, school, degree, seniority level, company size, connection count, or device-type.

6. The method of claim 1, wherein the user specification of the targeting criteria corresponds to a specific batch of member IDs corresponding to the targeted segment.

7. The method of claim 1, further comprising automatically assigning an unallocated percentage of the targeted segment of members to a control variant.

8. A system comprising:
a processor; and
a memory device holding an instruction set executable on the processor to cause the system to perform operations comprising:
receiving, via a user interface, a user specification of targeting criteria defining a targeted segment of members of an online social networking service for an A/B experiment
identifying a set of members of the online social networking service satisfying the user-specified targeting criteria, based on member profile attributes of the set of members;
receiving, via the user interface, a user specification of allocation criteria defining one or more variants of an A/B experiment and one or more corresponding allocation percentages;
assigning, to each of the user-specified variants, a subset of the set of members corresponding to the user-specific allocation percentage associated with the respective user-specified variant; and
recording, in a database, at least one data record associated with each of the variants, each data record indicating the subset of the set of members assigned to the respective variant.

9. The system of claim 8, further comprising:
determining that a particular member is accessing online content associated with the A/B experiment;
determining, based on the data record associated with a particular variant, that the particular member is included in a particular subset of the set of members that is assigned to the particular variant; and
displaying, via a user interface on a client device associated with the particular member, the particular variant in conjunction with the online content.

10. The system of claim 8, wherein the assigning further comprises identifying the members in each subset based on a hashing function.

11. The system of claim 8, wherein the user specification of the targeting criteria corresponds to a textual command including a member profile attribute and a value associated with the member profile attribute.

12. The system of claim 11, wherein the member profile attribute corresponds to a location, role, industry, language, skill, company, school, degree, seniority level, company size, connection count, or device-type.

13. The system of claim 8, wherein the user specification of the targeting criteria corresponds to a specific batch of member IDs corresponding to the targeted segment.

14. The system of claim 8, further comprising automatically assigning an unallocated percentage of the targeted segment of members to a control variant.

15. A non-transitory machine-readable storage medium comprising instructions that, when executed by one or more processors of a machine, cause the machine to perform operations comprising:
receiving, via a user interface, a user specification of targeting criteria defining a targeted segment of members of an online social networking service for an A/B experiment
identifying a set of members of the online social networking service satisfying the user-specified targeting criteria, based on member profile attributes of the set of members;
receiving, via the user interface, a user specification of allocation criteria defining one or more variants of an A/B experiment and one or more corresponding allocation percentages;
assigning, to each of the user-specified variants, a subset of the set of members corresponding to the user-specific allocation percentage associated with the respective user-specified variant; and
recording, in a database, at least one data record associated with each of the variants, each data record indicating the subset of the set of members assigned to the respective variant.

16. The storage medium of claim 15, further comprising:
determining that a particular member is accessing online content associated with the A/B experiment;
determining, based on the data record associated with a particular variant, that the particular member is included in a particular subset of the set of members that is assigned to the particular variant; and
displaying, via a user interface on a client device associated with the particular member, the particular variant in conjunction with the online content.

17. The storage medium of claim 15, wherein the assigning further comprises identifying the members in each subset based on a hashing function.

18. The storage medium of claim 15, wherein the user specification of the targeting criteria corresponds to a textual command including a member profile attribute and a value associated with the member profile attribute.

19. The storage medium of claim 15, wherein the user specification of the targeting criteria corresponds to a specific batch of member IDs corresponding to the targeted segment.

20. The storage medium of claim 15, further comprising automatically assigning an unallocated percentage of the targeted segment of members to a control variant.
